(19) United States
(12) Patent Application Publication
(10) Pub. No.: US 2015/0126121 A1
(43) Pub. Date: May 7, 2015

(54) DISPLAY APPARATUS AND METHOD OF CONTROLLING DISPLAY APPARATUS

(71) Applicant: Samsung Electronics Co., Ltd, Suwon-si (KR)

(72) Inventors: Dae-young NOH, Seoul (KR); Seung-pok LEE, Suwon-si (KR)

(73) Assignee: Samsung Electronics Co., Ltd, Suwon-si (KR)

(21) Appl. No.: 14/264,107

(22) Filed: Apr. 29, 2014

(30) Foreign Application Priority Data
Nov. 5, 2013 (KR) 10-2013-0133694

(51) Int. Cl. H04W 76/02; H04W 48/16

(52) U.S. Cl. CPC H04W 76/023; H04W 48/16; H04W 84/12
USPC 455/41.2

(57) ABSTRACT

A display apparatus includes a communication interface configured to search for connectable host apparatuses, a user interface configured to select a host apparatus to be connected to the display apparatus from among the searched host apparatuses, and a controller configured to request for transmission of image data with respect to the selected host apparatus, control the communication interface to receive image data corresponding to the request through a wireless communication method, and control the user interface to display the received image data.

### CROSS-REFERENCE TO RELATED APPLICATIONS

This application claims priority from Korean Patent Application No. 10-2013-0133694, filed in the Korean Intellectual Property Office on Nov. 5, 2013, the disclosure of which is incorporated herein by reference in its entirety.

### BACKGROUND OF THE INVENTION

1. Field of the Invention

Exemplary embodiments of the disclosure relate to a display apparatus and a method of controlling a display method thereof, and more particularly, to a display apparatus which allows a display in a wireless detachable system to select a host apparatus, and a method of controlling a display apparatus thereof.

2. Description of the Related Art

Recently, a host apparatus which performs computing is often connected to a display apparatus which displays the computing result wirelessly so as to improve mobility of an electronic apparatus, which includes the host apparatus and display. Specifically, a host apparatus transmits computed data, such as image processing, to a display apparatus using a wireless communication technology, and the display apparatus displays the received data. Hereinafter, such an electronic apparatus will be referred to as a wireless detachable system.

Such a wireless detachable system allows a user to place a host apparatus in a fixed location and use a display apparatus freely within an area where wireless communication is available, thereby providing the user with excellent mobility and a differentiated experience.

However, a conventional wireless detachable system merely allows a host apparatus to select a display apparatus to display image data, while a display apparatus cannot select a host apparatus.

As a user utilizes a display apparatus, the user should be able to move to a new host apparatus and set a wireless connection between the new host apparatus and the current display apparatus in order to change a connection state between a host apparatus and the display apparatus. However, in the conventional wireless detachable system, such a feature is not available, which causes inconvenience to the user.

### SUMMARY OF THE INVENTION

Exemplary embodiments of the disclosure relate to a display apparatus in a wireless detachable system which can select a host apparatus to be wirelessly connected to, and a method of controlling a display apparatus thereof.

Additional features and utilities of the present general inventive concept will be set forth in part in the description which follows and, in part, will be obvious from the description, or may be learned by practice of the general inventive concept.

Exemplary embodiments of the present disclosure provide a display apparatus which is connectable to a host apparatus wirelessly, the display apparatus includes a communication interface configured to search for connectable host apparatuses, a user interface configured to select a host apparatus to be connected to the display apparatus from among the searched host apparatuses, and a controller configured to request transmission of image data with respect to the selected host apparatus, control the communication interface to receive image data corresponding to the request through a wireless communication method, and control the user interface to display the received image data.

The communication interface may search for an apparatus which supports a predetermined protocol from among apparatuses which support the wireless communication method.

The wireless communication method may be a 802.11n or 802.11ac method using a 5 GHz band.

The user interface may display the searched host apparatuses and receive a selection regarding one of the displayed apparatuses from a user.

The user interface may select a pre-connected apparatus from among the searched host apparatuses.

The communication interface may receive both the image data and voice data corresponding to the image data, together, and the user interface may display the image data and output the voice data simultaneously.

The apparatus may further include a photographing unit configured to generate photographing data by photographing a subject, and the communication interface may transmit the generated photographing data to the host apparatus using the wireless communication method while receiving the image data.

The apparatus may further include a microphone configured to generate voice data by reading out a voice, and the communication interface may transmit the generated voice data to the host apparatus using the wireless communication method while receiving the image data.

The user interface may display the image data and includes a touch screen through which touch coordinates are input, and the communication interface may transmit the input touch coordinates to the host apparatus using the wireless communication method while receiving the image data.

The controller may generate second image data by an operation of an operating system of the display apparatus, and the user interface may display at least one of the received image data and the generated second image data.

Exemplary embodiments of the present disclosure also provide a method of controlling a display apparatus which is connectable to a host apparatus wirelessly, the method including searching for connectable host apparatuses, selecting a host apparatus to be connected to the display apparatus from among the searched host apparatuses, requesting transmission of image data with respect to the selected host apparatus, receiving image data corresponding to the request through a wireless communication method, and displaying the received image data.

The searching may include searching an apparatus which supports a predetermined protocol from among apparatuses which support the wireless communication method.

The wireless communication method may be a 802.11n or 802.11ac method using a 5 GHz band.

The selecting may include displaying the searched host apparatuses and receiving a selection regarding one of the displayed apparatuses from a user.

The selecting may include selecting a pre-connected apparatus from among the searched host apparatuses.

The receiving may include receiving the image data and voice data corresponding to the image data together, and the displaying may include displaying the image data and outputting the voice data simultaneously.

The method may further include generating photographing data by photographing a subject and transmitting the generated photographing data to the host apparatus using the wireless communication method while receiving the image data.

The method may further include generating voice data by reading out a voice and transmitting the generated voice data to the host apparatus using the wireless communication method while receiving the image data.

The method may further include receiving touch coordinates on a touch screen and transmitting the input touch coordinates to the host apparatus using the wireless communication method while receiving the image data.

The method may further include generating second image data by an operation of an operating system of the display apparatus, and the displaying may include displaying at least one of the received image data and the generated second image data.

A computer readable recording medium including a program to perform a method of controlling a display apparatus which is connectable to a host apparatus wirelessly according to an exemplary embodiment, the controlling method includes searching for connectable host apparatuses, selecting a host apparatus to be connected to the display apparatus from among the searched host apparatuses, requesting for transmission of image data with respect to the selected host apparatus, receiving image data corresponding to the request through a wireless communication method, and displaying the received image data.

Exemplary embodiments of the present disclosure also provide a display apparatus wirelessly connectable to a host apparatus, comprising: a user interface configured to display host apparatuses detected to be wirelessly connectable thereto and to provide for a user selection of at least one of the detected host apparatuses; and a controller configured to request for transmission of image data with respect to the selected host apparatus, to receive image data corresponding to the request through a wireless communication method, and to control the user interface to display the received image data.

In an exemplary embodiment, the user interface comprises a touch screen to perform input and output simultaneously.

In an exemplary embodiment, the user interface displays a wireless connection state with respect to a host apparatus.

In an exemplary embodiment, the controller determines the operation mode of the display apparatus.

In an exemplary embodiment, if a wake-up command is received through the user interface during a power-saving mode, or status information received from a wirelessly connected host apparatus indicating that the operation mode of the host apparatus is changed from a power-saving mode to a normal mode, the controller determines the operation mode of the display apparatus to be a normal mode.

In an exemplary embodiment, if a remaining battery charge amount of the display apparatus is determined to be less than a predetermined amount, the controller determines the operation mode of the display apparatus to be a power-saving mode, and if the operation mode of the display apparatus is changed to a power-saving mode, and then the battery status of the display apparatus is changed to a recharged state, the controller determines the operation mode of the display apparatus to be a normal mode again.

Exemplary embodiments of the present disclosure also provide a method of controlling a display apparatus wirelessly connectable to a host apparatus, the method comprising: displaying on a user interface host apparatuses wirelessly connectable to the display apparatus together with providing a user selection for each of the displayed host apparatuses; and requesting transmission of image data from a user selected host apparatus; wirelessly receiving image data corresponding to the request; and displaying the received image data.

In an exemplary embodiment, the user interface selects previously connected host apparatus among wirelessly connectable host apparatuses.

In an exemplary embodiment, the wirelessly receiving image data comprises receiving the image data and voice data corresponding to the image data together, and wherein the displaying comprises displaying the image data and outputting the voice data simultaneously.

In an exemplary embodiment, if a user inputs a touch command on a touch screen of the display apparatus while the image data is being received, the display transmits the touch command to the host apparatus using a wireless connection while the image data is being received.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a configuration of an electronic system according to an exemplary embodiment;

FIG. 2 is a block diagram illustrating a configuration of a host apparatus of FIG. 1;

FIG. 3 is a block diagram illustrating a configuration of a display apparatus of FIG. 2;

FIG. 4 is a detailed circuit diagram of a display apparatus of FIG. 3;

FIGS. 5 to 12 are views provided to explain an operation of an electronic system according to an exemplary embodiment;

FIGS. 13 to 17 are views provided to explain an operation of an electronic system according to another exemplary embodiment;

FIG. 18 is a flowchart provided to explain a control operation of a host apparatus according to an exemplary embodiment; and

FIG. 19 is a flowchart provided to explain a control operation of a display apparatus according to an exemplary embodiment.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

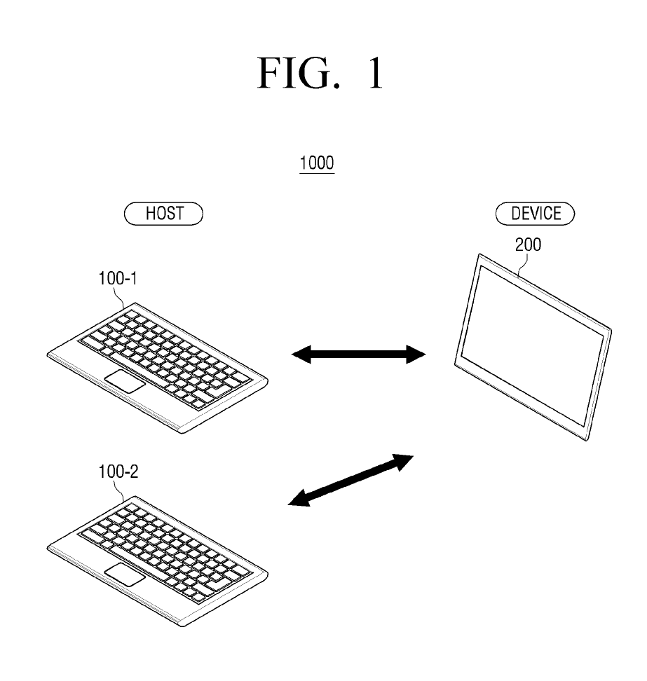

FIG. 1 is a block diagram illustrating configuration of a wireless detachable system according to an exemplary embodiment.

Referring to FIG. 1, a wireless detachable system 1000 (or a detachable system) comprises a plurality of host apparatuses 100-1 and 100-2, and a display apparatus 200.

Each host apparatus 100-1 and 100-2 generates image data to be displayed on the display apparatus 200, and transmits the generated image data to the display apparatus 200 through a wireless communication method. Specifically, the host apparatus 100 may generate image data to be displayed on the display apparatus 200 selected by a user, or may generate image data in response to a request for a wireless connection from the display apparatus 200, and may transmit the generated image data to the corresponding display apparatus 200. In this case, the host apparatus 100 may encode the image data (specifically, hardware encoding) and then transmit the encoded image data to the display apparatus 200.

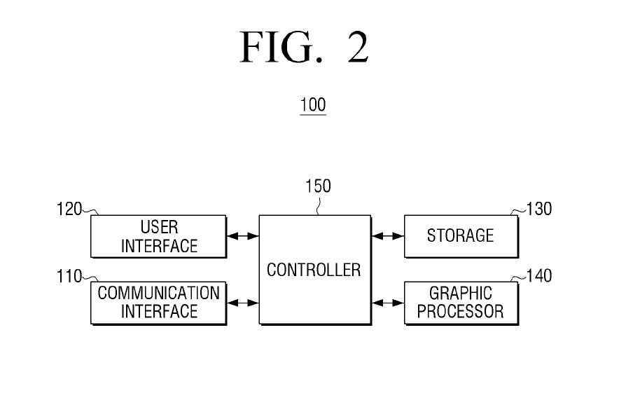

The host apparatus 100 may receive control information (specifically, touch coordinates input on a touch screen of a display apparatus) which is input at the display apparatus 200, photographing data which is photographed through a photographing unit, such as a web cam provided on the display apparatus 200, or voice data which is generated through a microphone provided on the display apparatus 200. The specific operations and configurations of the host apparatus 100 will be described with reference to FIG. 2.

The display apparatus 200 may search for the connectable host apparatuses 100-1 and 100-2, select a host apparatus to be connected from among the searched host apparatuses, and request a connection to the selected host apparatus (for example, host apparatus 100-1).

Accordingly, a wireless link is formed with the corresponding host apparatus 100-1, and image data is received through the formed wireless link in a wireless communication method. The display apparatus 200 which receives the image data may display the received image data on a touch screen of the display apparatus 200. Specifically, the display apparatus 200 may receive the encoded image data from the selected host apparatus 100-1 in a wireless communication method, decode the received encoded image data, and display the decoded image data.

The display apparatus 200 may transmit a control command which is input from a device such as the touch screen of the display apparatus 200, photographing data which is photographed through a photographing unit such as a web cam of the display apparatus 200, or voice data which is generated through a microphone of the display apparatus 200, to the host apparatus 100.

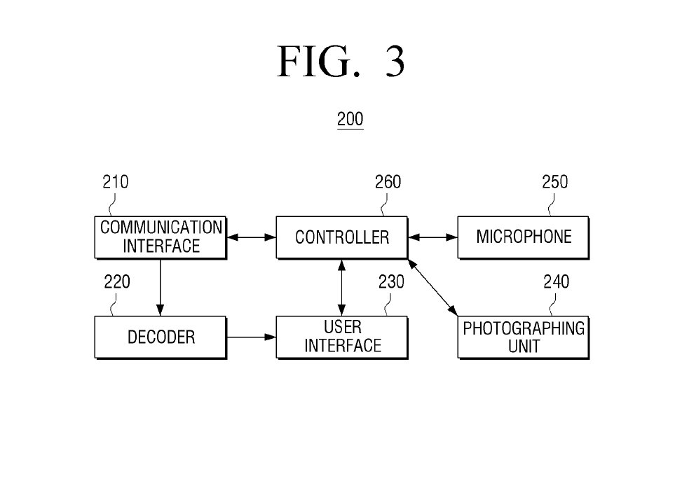

The display apparatus 200 may generate image data by operations of an operating system and display the generated image data. Specifically, the display apparatus 200 may generate image data using an operating system provided in the display apparatus 200 and display the generated image data. The specific operations and configuration of the display apparatus 200 will be described later with reference to FIG. 3.

As described above, the wireless detachable system 1000 according to an exemplary embodiment allows the display apparatus 200 to select a host apparatus among a plurality of host apparatuses to be wirelessly connected thereto, and thus, a user's convenience is improved. In addition, the wireless detachable system 1000 according to an exemplary embodiment may be operated using an operating system provided in the display apparatus 200 even when a wireless connection between the display apparatus 200 and the host apparatus 100 is weak or cut off, and thus, the usability and usability scope of the display apparatus 200 can be improved.

Meanwhile, in the above description regarding FIG. 1, a plurality of host apparatuses are connected to a single display apparatus, but a host apparatus may be connected to a plurality of display apparatuses depending on exemplary embodiments. That is, a host apparatus and a display apparatus may be connected to each other in various ways, such as in ratios such as, for example, 1:1, 1:n, n:1, n:n, etc.

Meanwhile, in the above description regarding FIG. 1, although a host apparatus directly generates image data, a host apparatus may be configured to receive image data from an external apparatus via cable and transmit the received image data to a display apparatus using a wireless communication method, that is, a host apparatus may be configured in a dongle type configuration. In addition, in the above description regarding FIG. 1, although a display apparatus directly displays an image, a display apparatus may be configured to process transmitted image data using a wireless communication method and transmit the processed image data to an external apparatus, that is, a display apparatus may be configured in a dongle type configuration.

FIG. 2 is a block diagram illustrating an overall configuration of an exemplary embodiment of a host apparatus of FIG. 1.

Referring to FIG. 2, the host apparatus 100 may consist of a communication interface 110, a user interface 120, a storage 130, a graphic processor 140, and a controller 150. The host apparatus 100 may be conventional desktop, notebook PC, smart phone, MP3 player, PMP, etc., and may be configured in a dongle type configuration as it operates by being connected to the above apparatuses.

Herein, the host apparatus 100 has a plurality of operation modes. The plurality of operation modes include a normal mode in which all elements of the host apparatus 100 operate and a power-saving mode in which less power is consumed than in the normal mode. Meanwhile, in the above exemplary embodiment, although the host apparatus 100 is described as only having one power-saving mode, the host apparatus 100 may include a plurality of power-saving modes.

The communication interface 110 is formed to connect the wireless detachable system 1000 to an external apparatus (not shown), and may be connected to an external apparatus not only through a Local Area Network (LAN) and Internet network, but also through a wireless communication method (wireless communication such as GSM, UMTS, LTE, WiBRO, WiFi, and Bluetooth).

The communication interface 110 searches for a connectable display apparatus. Specifically, the communication interface 110 may search for an apparatus which supports a predetermined protocol from among display apparatuses which support a wireless communication method for wireless transmission of image data. That is, the communication interface 110 may search for an apparatus which may receive image data transmitted from the host apparatus in real time, just like a display apparatus 200 which will be described later. Herein, the predetermined protocol is a protocol which receives image data that is transmitted in real time.

The communication interface 110 may perform a wireless connection with the display apparatus 200 selected from the user interface 120 which will be described later, from among searched display apparatuses. Meanwhile, if a searched display apparatus is a host apparatus which has a history of previously getting selected or connected, the display apparatus may be connected automatically without a user's selection.

The communication interface 110 receives a request for wireless connection with respect to the display apparatus 200. Specifically, when receiving a request for wireless connection from the display apparatus 200, the communication interface 110 may set a wireless connection with the display apparatus 200 which has transmitted the request. In this case, the wireless connection may be performed automatically according to a predetermined protocol, and may be performed after a user's confirmation.

The communication interface 110 transmits image data through a wireless communication method using a predetermined band. Specifically, the communication interface 110 may transmit image data which is encoded using 802.11n (bandwidth of 300 Mbps) with a 5 GHz band, which has a sufficient use distance in a household, or using 802.11ac (bandwidth of 1 Gbs) method, to the display apparatus 200. In this case, the communication interface 110 may transmit voice data along with the image data to the display apparatus 200. Meanwhile, although in the exemplary embodiment a WiFi (Wireless Lan) method is used, other wireless communication methods using the above band may also be used. In addition, in the exemplary embodiment, although 5 GHz band is used, other bands around 5 GHz may also be used. Meanwhile, in the exemplary embodiment, although the communication interface 110 transmits single image data to one display apparatus 200, the communication interface 110 may transmit single image data to a plurality of display apparatuses 200 or transmit a plurality of image data to each of a plurality of display apparatuses 200.

The communication interface 110 receives a control command from the display apparatus 200. Specifically, the communication interface 110 may receive a user's control command which is input at the display apparatus 200 using the above-described wireless communication method.

The communication interface 110 may transmit/receive control data to/from the display apparatus 200. Herein, the control data refers to data excluding image data and voice data, which is transmitted between the host apparatus 100 and the display apparatus 200, and may include a user's control command input from a user at the display apparatus 200 or at the host apparatus 100, an apparatus control command corresponding to the user's control command, status information on the host apparatus 100, status information on the display apparatus 200, etc. Herein, the status information may be information regarding an operation mode of a host apparatus and a display apparatus, a power state of a display apparatus (specifically, information on remaining battery charge), a display mode of a display apparatus, etc. Meanwhile, although in this exemplary embodiment control data is transmitted through a wireless communication method to transmit image data, control data may be received/transmitted using other communication methods (for example, Bluetooth, RF communication, IR communication, etc.) than the wireless communication which transmits image data.

The communication interface 110 receives photographing data from the display apparatus 200. Specifically, the communication interface 110 may receive photographing data which is photographed from a photographing unit of the display apparatus 200 through a wireless communication method. Herein, the photographing data may be image data such as JPEG, BMP, etc., or video data such as MP4, AVI, etc. Meanwhile, in the exemplary embodiment, although photographing data having only image data is described as being received, the received photographing data may also include voice data. Meanwhile, in the exemplary embodiment, although photographing data is transmitted using the wireless communication method which transmits image data, photographing data may be received through other communication methods (for example, Bluetooth, RF communication, IR communication, etc.) than the wireless communication method which transmits image data.

The communication interface 110 receives voice data from the display apparatus 200. Specifically, the communication interface 110 may receive voice data generated from a microphone of the display apparatus 200 through a wireless communication method. Herein, the voice data may be data such as MP3 or streaming data which is transmitted in real time. Meanwhile, in the exemplary embodiment, although voice data is transmitted using the wireless communication method which transmits image data, voice data may be received through other communication methods (for example, Bluetooth, RF communication, IR communication, etc.) than the wireless communication method which transmits/receives voice data. The voice data may be data for a telephone call service or a voice chatting service.

The user interface 120 includes various function keys through which a user may set or select various functions which are supported by the host apparatus 100, and may display various information provided by the host apparatus 100. The user interface 120 may be realized as an apparatus which performs input and output simultaneously, such as a touch screen, or may be realized as an apparatus which combines an input apparatus, such as a mouse and a keyboard, with an image displaying apparatus. In this case, the user interface 120 may include a keyboard unit, and may receive a user's control command through the keyboard unit.

Meanwhile, in the above description, although a display function is not performed in a host apparatus of a detachable system in the conventional technology area, the wireless detachable system according to an exemplary embodiment may include a display to display an image in the host apparatus 100. That is, the host apparatus 100 may further include an element to display another image which is the same as or different from an image displayed on the display apparatus 200.

The user interface 120 may display the searched display apparatus 200. Such an operation may be performed not only when the host apparatus 100 and the display apparatus 200 are connected for the first time, but also when the host apparatus 100 is being connected to another display apparatus 200. That is, the above operation may be performed when a connection to a currently-connected display apparatus is changed or another display apparatus is added to the connection.

The user interface 120 receives a selection of one of the searched display apparatuses 200. The selection is for changing a currently-connected display apparatus or adding a display apparatus as described above.

The storage 130 stores a program to drive the host apparatus 100. Specifically, the storage 130 may store a program which is a group of commands which are necessary to drive the host apparatus 100. Herein, the program includes not only an application program to provide a specific service, but also an operating program to drive an application program.

The storage 130 may store photographing data transmitted from the display apparatus 200. In addition, the storage 130 may store voice data transmitted from the display apparatus 200.

The storage 130 may be realized as a storage medium in the host apparatus 100, or as an external storage medium such as a removable disk including a USB memory, a web server via network, etc.

The graphic processor 140 generates image data to be displayed on the display apparatus 200. Specifically, the graphic processor 140 may generate image data corresponding to a user's control command input through the display apparatus 200 (or a user's control command input through the user interface 120). Herein, the generated image data may be real-time streaming data.

Meanwhile, in the exemplary embodiment, although the graphic processor 140 generates only image data, the graphic processor 140 may also generate voice and video streaming data which includes both image data and voice data. The video streaming data may be data according to a High-Definition Multimedia Interface (HDMI) method.

The graphic processor 140 generates image data including received photographing data. Specifically, the graphic processor 140 may generate image data including photographing data which is received through the communication interface 110. In this case, the graphic processor 140 may use the received photographing data as it is, or may use the received photographing data by adjusting its size and/or ratio. That is, the graphic processor 140 may perform image-processing with respect to received photographing data, and generate image data to be displayed on the display apparatus 200 using the processed photographing data.

Meanwhile, the graphic processor 140 may generate image data to receive only a touch command. For example, if the host apparatus 100 is a PC, and the display apparatus 200 operates as a touch pad, image data informing that the display apparatus 200 operates as a touch pad may be generated since the touch pad needs to display an image. However, an exemplary embodiment may be realized without generating and transmitting image data.

The graphic processor 140 performs hardware-encoding with respect to generated image data. Specifically, the graphic processor 140 may perform hardware-encoding with respect to output image data independently without any control from the controller 150 (specifically, CPU) which will be described later. Herein, the encoding may use a standard H.264 method, or may use another encoding method which may prevent deterioration of image quality and perform processing in sufficient bandwidth. As such, the graphic processor 140 performs encoding with respect to image data independently without any intervention from the controller 150, and thus, the latency of transmitted image data approaches ‘0’. In addition, as image data is encoded (specifically, compressed) and transmitted, an image of high resolution may be transmitted using WiFi which has a comparatively small bandwidth.

The graphic processor 140 may perform hardware encoding with respect to voice data. Meanwhile, in the exemplary embodiment, although the graphic processor 140 encodes image data and voice data individually, if the data output from the graphic processor 140 is data which has voice and image portions, such as HDMI, the image data and voice data portions may be hardware-encoded simultaneously. In this case, the graphic processor 140 may compress the data input as HDMI by encoding and transmitting the data in accordance with a bandwidth.

Meanwhile, in the exemplary embodiment, although the graphic processor 140 generates image data and performs encoding with respect to the generated image data, such an encoding operation may be performed in a separate apparatus using a separate encoder. In addition, in the exemplary embodiment, although hardware encoding is used as an encoding method, a software encoding method may be used if the capacity of the CPU is sufficient.

In the exemplary embodiment, although the graphic processor 140 generates image data, image data may be generated by a separate external apparatus, and the graphic processor 140 may perform only encoding regarding image data which is transmitted from outside.

The controller 150 controls each element of the host apparatus 100. Specifically, the controller 150 determines an operation mode of the host apparatus 100. More specifically, if there is no input from a user for a predetermined period of time or if no job is performed for a predetermined period of time, the controller 150 may determine the operation mode of the host apparatus 100 to be a power-saving mode. If the controller 150 receives status information indicating that the operation mode of the display apparatus 200 is changed to a power-saving mode or the display mode of the display apparatus 200 is changed to the second display mode (a mode where the display apparatus operates based on its O/S) through the communication interface 110, the operation mode of the host apparatus 100 may be determined to be a power-saving mode.

Meanwhile, if a wake-up command is received from a user through the user interface 120 in a power-saving mode, or if status information indicating that the operation mode of the display apparatus 200 is changed from a power-saving mode to a normal mode is received through the communication interface 110, the controller 150 may determine the operation mode of the host apparatus 100 to be a normal mode. Meanwhile, in the above exemplary embodiment, although the operation mode of the host apparatus 100 is described to be changed from a power-saving mode to a normal mode or from a normal mode to a power-saving mode, the same technical feature may also be applied when the operation mode is changed from a power-off mode to a normal mode by a user's power-on operation.

In addition, the controller 150 may determine the operation mode of the host apparatus 100 according to the display mode of the display apparatus 200 or a connection status with the display apparatus 200. Specifically, if information regarding the display mode of the display apparatus 200 is received through communication interface 110 as status information, and the display apparatus 200 operates in the second display where only the second image data which is generated therein is displayed, or a connection with the display apparatus 200 is cut off, there is no need to provide an image to the display apparatus 200 from the host apparatus 100, and thus, the controller 150 may determine the operation mode of the host apparatus 100 to be a power-saving mode. Meanwhile, in the exemplary embodiment, although information regarding the display mode is described to be received as status information in order to determine the operation mode of the host apparatus 100, the operation mode of the host apparatus 100 may be determined according to a wireless connection state with the display apparatus 200.

Further, the controller 150 may determine the operation mode of the host apparatus 100 according to a battery state of the display apparatus 200. Specifically, if information regarding a remaining battery charge of the display apparatus 200 is received through the communication interface 110 as status information and the received remaining battery charge is less than a predetermined remaining amount, the controller 150 may determine the operation mode of the host apparatus 100 to be a power-saving mode. As such, if the operation mode of the host apparatus 100 is changed to a power-saving mode, and then the battery state of the display apparatus 200 is changed to a recharged state, the controller 150 may determine the operation mode of the host apparatus 100 to be a normal mode again. The information indicating that the battery state of the display apparatus 200 is changed to a recharged state may be received as the above-described status information.

The controller 150 may control each element of the host apparatus 100 to correspond to the determined operation mode. Specifically, if the operation mode of the host apparatus 100 is changed to a power-saving mode, the controller 150 may control to operate only a predetermined element or elements, and may control the overall operations such that the storage 130 and the graphic processor 140 are not operated.

For example, if a user inputs a power-off command through the user interface 120 or a command to enter into a power-saving mode, the controller 150 may control each element of the host apparatus 100 to have a power state which corresponds to the power-saving mode (or a power-off mode). In addition, the controller 150 may control the communication interface 110 to notify a user that the operation mode of the host apparatus 100 has been changed. If such information is transmitted to the display apparatus 200, the operation mode of the display apparatus 200 may also change to a power-saving mode or a power-off mode. As described above, the host apparatus 100 according to an exemplary embodiment transmits information regarding whether the operation mode of the host apparatus 100 is changed to the display apparatus 200 as status information, and thus, a user may change the status of both the host apparatus 100 and the display apparatus 200 together with only a manipulation of one apparatus among the two apparatuses.

If the operation mode of the host apparatus 100 is changed to a normal mode, the host apparatus 100 may be controlled such that those elements which do not operate in a power-saving mode are woken up. Such an operation may also be applied when the display apparatus 200 requests for a connection from the host apparatus 100. That is, if the host apparatus 100 is in a power-saving mode, the display apparatus 200 may operate by its own O/S, or if the display apparatus 200 requests for a wireless connection with the corresponding host apparatus 100 while the display apparatus 200 is connected to another host apparatus wirelessly, the controller 150 may control to wake up each element of the host apparatus 100 so that an image may be provided to the corresponding display apparatus 200.

When the operation mode of the host apparatus 100 is changed, the controller 150 may control the communication interface 110 to transmit the changed operation mode of the host apparatus 100 to the display apparatus 200 as status information.

For example, if the host apparatus 100 is in a power-saving mode or a power-off mode and a wake-up command is input from a user through the user interface 120, the controller 150 may control to wake up the host apparatus 100 such that the operation mode of the host apparatus 100 is changed to a normal mode. That is, the controller 150 may control to boot the host apparatus 100. When an operating system stored in the storage 130 is loaded onto a volatile memory and booting is completed through this process, the graphic processor 140 may be controlled to generate image data by the booting process and image data corresponding to a user interface window supported by the operating system, and the communication interface 110 may be controlled to transmit the generated image data to the display apparatus 200 using a wireless method.

At the same time, the controller 150 transmits information that its own operation mode is changed to the display apparatus 200 through the communication interface 110, and thus, the display apparatus 200 may also be woken up without any separate user manipulation.

When a search is performed for the connectable display apparatus 200 as described above, the controller 150 may control the user interface 120 to display information regarding the searched display apparatus. Accordingly, a user may transmit a connection command to the new display apparatus discovered as a result of the search.

The controller 150 may perform a connection with the discovered wireless display apparatus. Specifically, if a connection command of the discovered display apparatus is input from a user, or the discovered display apparatus is a display apparatus which is to be connected automatically, the controller 150 may perform a connection with the discovered wireless display apparatus (for example, a pairing), and control the graphic processor 140 and the communication interface 110 such that image data can be transmitted to the discovered display apparatus.

If a user's control command is received through the user interface 120 (specifically, a keyboard unit), the controller 150 may control the graphic processor 140 to generate image data corresponding to the first user's control command which is input. The controller 150 may control the communication interface 110 to transmit the generated image data (specifically, encoded image data) to the display apparatus 200.

Meanwhile, if a user's control command which is input through the user interface 120 is a second user's control command to control the operation of the display apparatus 200 (for example, a command to change the operation mode such as a power-off command and a power-on command), the controller 150 may control the communication interface 110 to transmit control data corresponding to the second user's control command to the display apparatus 200.

In addition, when a user inputs a control command through a user interface 230 (specifically, a touch screen) provided on the display apparatus 200, the display apparatus 200 transmits the input control command to the host apparatus 100 as control data. Accordingly, if control data corresponding to the user's control command is received from the display apparatus 200, the controller 150 may control the graphic processor 140 to generate image data corresponding to the received user's control command.

For example, when a command to play a movie file stored in the host apparatus 100 is input through the user interface 120, the controller 150 may control the graphic processor 140 and the communication interface 110 to generate image data regarding the movie file stored in the storage 130 in a streaming method and transmit the generated image data to the display apparatus 200. If a command to pause the image is input through a touch screen provided on the user's display apparatus 200 while the streaming image corresponding to the movie file is displayed on the display apparatus 200, the display apparatus 200 transmits the image pause command to the host apparatus 100 as control data. In this case, the host apparatus 100 may control the graphic processor 140 and the communication interface 110 such that the image which is stopped according to the input image pause command is displayed on the display apparatus 200.

Meanwhile, in the above exemplary embodiment, although the streaming image is describe to correspond with a single content (or output of driving one program), the streaming image may be output as a plurality of contents. Specifically, a user may operate a plurality of application programs installed in an operating system of the host apparatus 100 simultaneously. For example, if a user executes a second application program to play a music content additionally while executing a first application program for Internet surfing (such an execution command may be input through a touch screen of the user interface of the display apparatus 200 or a keyboard or a mouse of the user interface 230 of the host apparatus 100), the controller 150 may operate the second application program while driving the first application program. Accordingly, the controller 150 may generate a user interface window (that is, image data) for Internet surfing according to the result of operating the first application program and sound data according to the result of operating the second application program, and may control the graphic processor 140 to generate real-time streaming data having the generated image data and sound data. The controller 150 may control the communication interface 110 to transmit the generated real-time streaming data to the display apparatus 200 through a wireless communication method.

As described above, the host apparatus 100 according to an exemplary embodiment may be wirelessly connected or a connection of the host apparatus 100 may be cut off upon a request from the display apparatus 200, and thus, a user may set a connection between a display apparatus and a host apparatus easily. In addition, the host apparatus 100 according to an exemplary embodiment encodes image data and transmits the encoded image data to the display apparatus 200, and thus, image data of high resolution may be transmitted with only a low wireless resource available, and the host apparatus 100 may receive image data photographed by the display apparatus 200 and various control data through the same wireless communication method.

Meanwhile, in the above exemplary embodiment, although the graphic processor 140 and the controller 150 are described as separate elements, they may be configured as one element.

FIG. 3 is a block diagram illustrating an exemplary configuration of a display apparatus 200 of FIG. 1.

Referring to FIG. 3, the display apparatus 200 may consist of a communication interface 210, a decoder 220, a user interface 230, a photographing unit 240, a microphone 250, and a controller 260.

Herein, the display apparatus 200 has a plurality of operation modes. The plurality of operation modes include a normal mode in which all elements operate and a power-saving mode in which power is consumed less than in the normal mode, according to a power state. Meanwhile, in the above exemplary embodiment, although the display apparatus 200 is described as having only one power-saving mode, the display apparatus 200 may include a plurality of power-saving modes.

In addition, the display apparatus 200 has a plurality of display modes. Herein, the plurality of display modes include a first display mode where an image transmitted from the host apparatus 100 is displayed according to an image source displayed on the display apparatus 200, a second display mode where an image generated directly by the display apparatus 200 is displayed, and a third display mode where an image transmitted from the host apparatus 100 and an image generated directly by the display apparatus 200 are displayed together.

The communication interface 210 searches for a connectable host apparatus 100. Specifically, the communication interface 210 may search for an apparatus which supports a predetermined protocol from among apparatuses which support 802.11n method or 802.11 ac method using a 5 GHz band. That is, the communication interface 210 may search for a host apparatus which can transmit image data wirelessly. Herein, the predetermined protocol is a protocol to transmit image data which is transmitted in real time.

The communication interface 210 may perform a wireless connection with a host apparatus which is selected from the user interface 230, which will be described later, from among searched host apparatuses. Specifically, the communication interface 210 may request a wireless connection with respect to a host apparatus to perform a wireless connection from among searched host apparatuses. In the above process, the display apparatus 200 may transmit its own apparatus information (screen resolution, whether a web cam is included, etc.). Meanwhile, if the searched and discovered host apparatus is selected previously or has a history of being connected previously, the connection may be performed without a user's selection.

The communication interface 210 receives a request for a wireless connection from the host apparatus 100. If such a request is performed, the communication interface 210 may form a wireless link with the host apparatus 100 making the request.

The communication interface 210 receives image data (hereinafter, image data transmitted from a host apparatus will be referred to as first image data for convenience of explanation) using a wireless communication method. Specifically, the communication interface 210 may receive the first image data transmitted through the communication interface 110 of the host apparatus 100 using 802.11n (bandwidth of 300 Mbps) with a 5 GHz band which has a sufficient use distance in a household or using 802.11ac (bandwidth of 1 Gbs) method to the display apparatus 200. In this case, the communication interface 210 may receive voice data along with the image data simultaneously. Herein, the received data may be real-time streaming data according to an HDMI interface method. Meanwhile, in the exemplary embodiment, although a WiFi (Wireless Lan) method is described as being used, other wireless communication methods using the above band may also be used. In addition, in the exemplary embodiment, a 5 GHz band is used, but other bands around 5 GHz may also be used.

The communication interface 210 transmits a control command using a wireless communication method. Specifically, the communication interface 210 may transmit a use's control command input through the user interface 230 which will be described later to the communication interface 110 of the host apparatus 100. Meanwhile, in the exemplary embodiment, although a control command is described as being transmitted through a wireless communication method for receiving image data, that is, both receiving image data and transmitting a control command are described as being performed through a single wireless link, a plurality of wireless links may be formed between a host apparatus and a display apparatus such that image data is transmitted through one wireless connection and a control command is transmitted through another wireless connection.

The communication interface 210 transmits/receives control data to/from the host apparatus 100. Herein, the control data refers to data excluding image data and voice data, which is transmitted between the host apparatus 100 and the display apparatus 200, and may include a user's control command input from a user on the display apparatus 200 or the host apparatus 100, an apparatus control command corresponding to the user's control command, status information on the host apparatus 100, status information on the display apparatus 200, etc. Accordingly, the communication interface 210 may transmit/receive the status information of the host apparatus 100 and the status information of the display apparatus 200 to/from the communication interface 110 of the host apparatus 100 through a wireless communication method. Herein, the status information may be information regarding an operation mode of the host apparatus 100 and the display apparatus 200, a power state of the display apparatus 200 (specifically, information on residual battery), etc. Meanwhile, in the exemplary embodiment, although control data is described as being transmitted/received through a wireless communication method for transmitting image data, control data may be received/transmitted using other communication methods (for example, Bluetooth, RF communication, IR communication, etc.) than the above wireless communication method.

The communication interface 210 also transmits photographing data to the host apparatus 100. Specifically, the communication interface 210 may transmit photographing data generated by the photographing unit 240, which will be described later, to the host apparatus 100 through a wireless communication method. Meanwhile, in the exemplary embodiment, although photographing data is described as being transmitted through a wireless communication method for receiving image data, photographing data may be transmitted to the host apparatus 100 through other methods (for example, Bluetooth, RF communication, etc.) than the above wireless communication method.

The communication interface 210 also transmits voice data to the host apparatus 100. Specifically, the communication interface 210 may transmit voice data generated from the microphone 250, which will be described later, to the host apparatus 100 using a wireless communication method. Herein, the voice data may be data such as MP3 or a streaming data which is transmitted in real time. Meanwhile, in the exemplary embodiment, although voice data is described as being transmitted through a wireless communication method for receiving image data, voice data may be transmitted to the host apparatus 100 using other methods (for example, Bluetooth, RF communication, etc.) than the above wireless communication method.

The communication interface 210 detects a wireless connection state with the host apparatus 100. Specifically, the communication interface 210 may detect whether a wireless connection state with the host apparatus 100 is higher/lower than a predetermined state. Herein, the predetermined state refers to a wireless connection state where an image may be displayed in the host apparatus 100 with sufficient image quality and/or low delay even if there is a little delay, and may be adjusted by a system state or a user's setting. Meanwhile, in the exemplary embodiment, although the communication interface 210 is described to detect a wireless connection state with the host apparatus 100, another separate exclusive element may detect a wireless connection state with the host apparatus 100. In addition, in the exemplary embodiment, although only a wireless connection state is described as being used, a wireless connection state may be detected according to whether there is a screen disconnection or noise while an image is displayed.

The communication interface 210 may be connected to an Internet network through a wireless communication method. Specifically, the communication interface 210 may be connected to an Internet network through a wireless communication method when the display mode of the display apparatus 200 is the second display mode. Herein, the wireless communication method may be the same method as the wireless communication method for a connection with the host apparatus 100, or may be a different method from the wireless communication method for a connection with the host apparatus 100.

The decoder 220 performs hardware decoding with respect to received image data. Specifically, the decoder 220 may perform decoding with respect to received data through a decoding method corresponding to an encoding method of the host apparatus 100, and output data according to an HDMI method. Herein, the decoding may use a standard H.264 method or use another decoding method which is different from the standard H.264 method. Meanwhile, in the exemplary embodiment, although decoding is described as being performed using the separate decoder 220, that is, hardware decoding is performed, the controller 260 itself may perform decoding (that is, operations of software decoding).

The user interface 230 may include a plurality of function keys through which a user sets or selects various functions supported by the display apparatus 200, and may display various information provided by the display apparatus 200. The user interface 230 may be realized as an apparatus which performs input and output simultaneously, such as a touch screen, or may be realized as an apparatus which combines an input apparatus such as various buttons with a display apparatus which displays an image. It is desirable that the user interface 230 of the display apparatus 200 is configured as a touch screen.

The user interface 230 displays the received first image data. Specifically, if the display mode of the display apparatus is the first display mode, the user interface 230 may display image data which is received through the communication interface 210. Meanwhile, if data which combines image data and voice data is received through the communication interface 210, that is, video streaming data is received, the user interface 230 may divide the received video streaming data into image streaming data and voice streaming data, display an image corresponding to the divided image streaming data and output voice corresponding to the divided voice streaming data simultaneously. The image streaming data and the voice streaming data may be data according to a single content or data according to a plurality of contents. That is, the image streaming data may be an output result of an application program which is related to Internet surfing, and voice streaming data may be an output result of an application program which is related to playing sound source data.

The user interface 230 displays image data generated by the controller 260 which will be described later (hereinafter, image data generated directly by a display apparatus will be referred to as second image data for convenience of explanation). Specifically, if the display mode of the display apparatus 200 is the second display mode, the user interface 230 may display the second image data generated by an operation of an O/S of the display apparatus 200. In this case, the user interface 230 may display the second image data while displaying the first image data received from the host apparatus 100. That is, if the display mode of the display apparatus 200 is the third display mode, the user interface 230 may display the first image data and the second image data together. In this case, the first image data and the second image data may be displayed at the ratio of 1:1. Alternatively, the first and second image data may be displayed in a PIP form in which the first image data is displayed on the main screen and the second image is displayed on the sub screen, or vice versa.

The user interface 230 displays status information of the host apparatus 100. Specifically, if status information indicating that the operation mode of the host apparatus 100 is changed is received through the communication interface 210, the user interface 230 may display that the operation mode of the host apparatus 100 is changed. In this case, the user interface 230 may display that the operation mode of the display apparatus 200 is also changed in accordance with the change in the operation mode of the host apparatus 100.

The user interface 230 displays a searched host apparatus. Specifically, the user interface 230 may display a searched host apparatus in the communication interface 210. The user interface 230 may receive a selection of a host apparatus to be connected from among searched host apparatuses.

The user interface 230 also displays a state of a battery. Specifically, the user interface 230 may display status information of a battery (for example, whether the battery is being recharged, how much battery currently remains, whether the battery needs to be recharged as the remaining battery is less than a predetermined amount, etc.).

The user interface 230 also displays a wireless connection state with respect to a host apparatus. Specifically, if a wireless connection state with respect to a host apparatus is less than a predetermined state, that is, if the wireless connection is a state where image data transmitted from the host apparatus 100 cannot be displayed, the user interface 230 may display that the operation mode needs to be changed. On the other hand, if the state is changed such that image data transmitted from the host apparatus 100 can be displayed while an image is displayed by its own operating system, the user interface 230 may display that the operation mode can be changed.

The user interface 230 receives a selection of the display mode of the display apparatus 200. Specifically, the user interface 230 may include a physical button or a software button, and may receive a selection of an image to be displayed from a user from among the first image data (image data received from the host apparatus 100) and/or the second image data (image data generated directly by the display apparatus 200). Such a selection operation may be performed at a time when the user wants or at a time when a wireless connection state with respect to the above-described host apparatus is changed.

The user interface 230 may include various sensors, and may treat data input from each sensor as a control command.

Meanwhile, in the exemplary embodiment, although image data received from the host apparatus is described as being displayed on the display apparatus 200, if the display apparatus is realized in a dongle type configuration, image data which is received through a wireless communication method may be decoded, and the decoded image data may be transmitted to a separate display apparatus via cable.

The photographing unit 240 photographs a subject and generates photographing data. Specifically, the photographing unit 240 may include a lens which collects light of a subject and causes an optical image to be formed on a photographing area, a photographing element which photo-electrically converts light entered through a lens, and an AD converter which converts an analog signal of a photographing unit to a digital signal and outputs the converted signal. In this case, the photographing unit may be a Charge Coupled Device (CCD) photographing element or a Complementary Metal Oxide Semiconductor (CMOS) photographing element.

The microphone 250 reads out voice and generates voice data. Specifically, the microphone 250 may generate voice data using at least one microphone. Such voice data may be combined with photographing data generated by the photographing unit 240 to become video data.

The controller 260 controls each element of the display apparatus 200. Specifically, the controller 260 determines the operation mode of the display apparatus 200. More specifically, if there is no input from a user for a predetermined period of time, or if no job is performed for a predetermined period of time, the controller 260 may determine the operation mode of the display apparatus 200 to be a power-saving mode. If status information indicating that the operation mode of the host apparatus 100 has changed to a power-saving mode is received through the communication interface 210, the controller 260 may determine the operation mode of the display apparatus 200 to be a power-saving mode.

Meanwhile, if a wake-up command is received through the user interface 230 during a power-saving mode, or status information indicating that the operation mode of the host apparatus 100 has changed from a power-saving mode to a normal mode is received through the communication interface 210, the controller 260 may determine the operation mode of the display apparatus 200 to be a normal mode.

In addition, the controller 260 may determine the operation mode of the display apparatus 200 according to a battery state of the display apparatus 200. Specifically, if the remaining battery of the display apparatus 200 is less than a predetermined amount, the controller 260 may determine the operation mode of the display apparatus 200 to be a power-saving mode. As such, if the operation mode of the display apparatus 200 is changed to a power-saving mode, and then the battery state of the display apparatus 200 is changed to a recharged state, the controller 260 may determine the operation mode of the display apparatus 200 to be a normal mode again.

The controller 260 may determine a display mode according to a wireless connection state with respect to a host apparatus. Specifically, if a wireless connection state with respect to a host apparatus is less than a predetermined state while the received first image data is displayed, the controller 260 may control to display the generated second image data, that is, the controller 260 may control the display apparatus 200 to operate in the second display mode. On the other hand, if a wireless connection state with respect to a host apparatus is higher than a predetermined state while the generated second image data is displayed, the controller 260 may control to display the received first image data, that is, the controller 260 may control the display apparatus 200 to operate in the first display mode or the third display mode. Meanwhile, in the exemplary embodiment, although a display mode is described as being determined according to a wireless connection state with respect to a host apparatus, change in a wireless connection state may be displayed to a user and a display mode may be received from the user. In addition, if the first image data is receivable, a display mode may be changed freely according to a user's selection.

The controller 260 may control each element of the display apparatus to correspond to a determined operation mode. Specifically, if the operation mode of the display apparatus 200 is changed to a power-saving mode, the controller 260 may control to operate only a predetermined element/component, and may control the display apparatus 200 such that the decoder 220, the user interface 230, the photographing unit 240, and the microphone 250 are not operating.

If the operation mode of the display apparatus 200 is changed to a normal mode, each element of the display apparatus 200 may be controlled such that elements which are not operating in a power-saving mode can be woken up.

If the operation mode of the display apparatus 200 is changed, the controller 260 may control the communication interface 210 to transmit the changed operation mode of the display apparatus 200 to the host apparatus 100 as status information.

The controller 260 searches for a host apparatus. Specifically, the controller 260 may control the communication interface 210 to search for a connectable host apparatus whenever a user's search command is input or at predetermined intervals. If a search is performed for a connectable host apparatus, the controller 260 may control the user interface 230 to display the searched host apparatus. Meanwhile, the search and display operations may be performed while the host apparatus 100 and the display apparatus 200 are connected wirelessly. For example, if a search is performed for a new host apparatus, the controller 260 may control the communication interface 210 to perform a wireless connection with respect to a selected host apparatus from among the searched host apparatuses.

If image data is received through the communication interface 210, the controller 260 may control the communication interface 210, the decoder 220 and the user interface 230 to decode the received image data and display the data on the user interface 230.

If a user's control command is input through the user interface 230, the controller 260 may control the communication interface 210 to transmit the received user's control command to the host apparatus 100 as control data.

If a photographing command is input from the host apparatus 100, the controller 260 may control the photographing unit 240 to generate photographing data, and control the communication interface 210 to transmit the generated photographing data to the host apparatus 100.

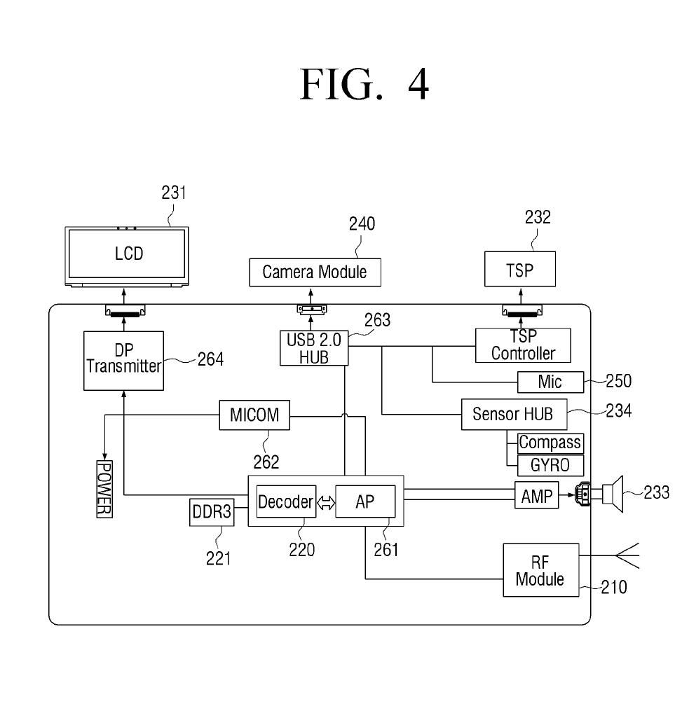

If the display mode of the display apparatus 200 is the second display mode or the third display mode, the controller 260 may control the user interface 230 to generate an image to be displayed on the user interface 230 using its own operating system and display the generated image. In this case, the controller 260 may include a memory element for operation. The specific configuration of the controller 260 will be described later with reference to FIG. 4.

As described above, according to the exemplary embodiment, it is possible for the display apparatus 200 to select a host apparatus, and thus, user convenience can be improved. In addition, the display apparatus according to an exemplary embodiment 200 may operate using its own operating system provided in the display apparatus 200, and thus, the usability and usability scope of the display apparatus 200 can be improved.

FIG. 4 is a detailed circuit diagram of a display apparatus of FIG. 3.

Referring to FIG. 4, the display apparatus 200 may include the communication interface 210, the decoder 220, the user interface 230, the photographing unit 240, the microphone 250, and the controller 260.

The communication interface 210 is configured as an RF module, and receives data from the host apparatus 100 through a WiFi method and transmits the received data to a wireless access point (AP) 261. The communication interface 210 transmits data to be transmitted to the host apparatus 100 through a WiFi method. Herein, the data to be transmitted may be a control command input through the user interface 230, information measured from various sensors, and photographing data generated by the photographing unit 240. Meanwhile, in the exemplary embodiment, the received data is described as being transmitted to the AP 261, the received data may be transmitted to the decoder 220 first.

The decoder 220 receives encoded image data from the AP 261 and performs decoding with respect to the input image data. In this case, the decoder 220 may perform decoding using an exclusive memory element 221. The decoder 220 receives encoded voice data from the AP 261 and performs decoding with respect to the input voice data. Meanwhile, in the exemplary embodiment, although the decoder 220 is described to perform decoding, decoding may also be performed by an AP.

The user interface 230 may consist of a display 231 to output an image, a touch screen 232, a speaker 233, and a sensor 234.

The display 231 may receive data based on an HDMI method from the AP 261 through a transmitter 264, and display an image using the data based on an HDMI method.

The touch screen 232 may be disposed on the display 231, and transmit a coordinates value touched by a user to the AP 261 as a control command. In this case, the touch screen 232 may output a control command through a USB method. Meanwhile, in the exemplary embodiment, although the display 231 and the touch screen 232 are described as separate elements from each other, the display 231 and the touch screen 232 may also be realized as one apparatus.

The speaker 233 outputs voice data. Specifically, the speaker 233 may receive and output decoded voice data.

The sensor 234 may include a gyro sensor to detect the disposition direction and location of the display apparatus 200, and may output the output data of a sensor through a USB method. The output data of the sensor 234 may be treated as control data and may be transmitted to the host apparatus 100 through the communication interface 210.

The photographing unit 240 generates photographing data having an image. The photographing unit 240 may transmit the generated photographing data to the AP 261 using a USB method.

The microphone 250 reads out voice and generates voice data. The microphone 250 may transmit voice data to the AP 261 through a USB method. Meanwhile, in the exemplary embodiment, although the photographing unit 240 and the microphone 250 are described as separate elements from each other, one element may perform the functions of both the photographing unit 240 and the microphone 250 simultaneously.

The controller 260 controls each and every element of the display apparatus 200. Specifically, the controller 260 may include the AP 261, a micom 262, a USB 263, and a transmitter 264.

The AP 261 can control each element of the display apparatus 200, and may perform the operations of the controller 260 which have been described above with reference to FIG. 3. Specifically, if data is received through the communication interface 210, the AP 261 may determine whether the received data is image data or control data to decode and output image data to the LCD 231 and process control data according to a pre-stored process.

The AP 261 may control the communication interface 210 to receive a control command received through a touch screen according to a USB method and photographing data and to transmit the received control command and photographing data.

The AP 261 is operated using an operating system. Herein, the operating system may be the Android. Meanwhile, in the exemplary embodiment, although the Android is described as being used as an operating system, other systems may also be used as an operating system.

The micom 262 controls the initialization and operation state of each element of the display apparatus 200.

The USB 263 transmits/receives data in the display apparatus 200. The transmitter 264 transmits image data decoded in the decoder 220 to the display 231.

As described above, the display apparatus 200 according to an exemplary embodiment includes an AP which can operate by itself, and thus, it is possible for the display apparatus 200 to request for a connection with respect to a host apparatus.

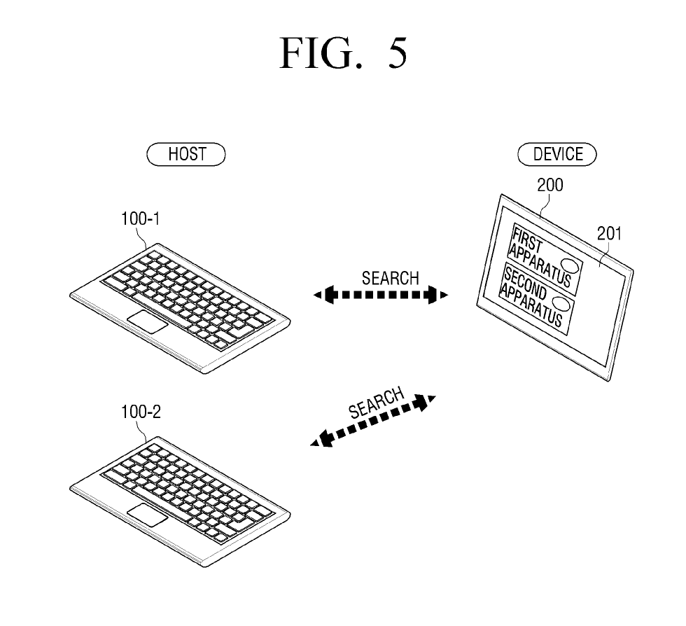

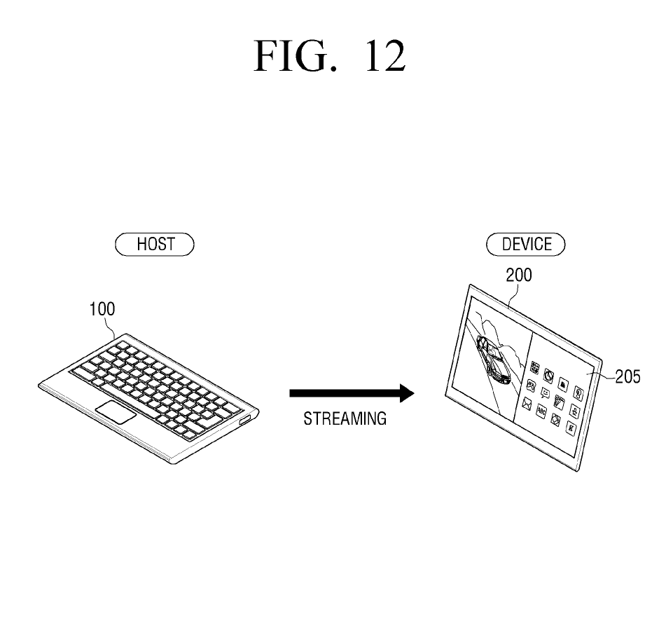

FIGS. 5 to 12 are views provided to explain an operation of an electronic system of FIG. 12.

Referring to FIG. 5, the display apparatus 200 may search for connectable host apparatuses 100-1 and 100-2 upon a user's request or at predetermined intervals. The display apparatus 200 may display the searched host apparatuses 100-1 and 100-2 and receive a selection of a host apparatus to be connected from a user. Meanwhile, in the exemplary embodiment, although a host apparatus selected from a user is described as being connected from among searched apparatuses, an apparatus which has a history of being connected previously may be selected automatically.

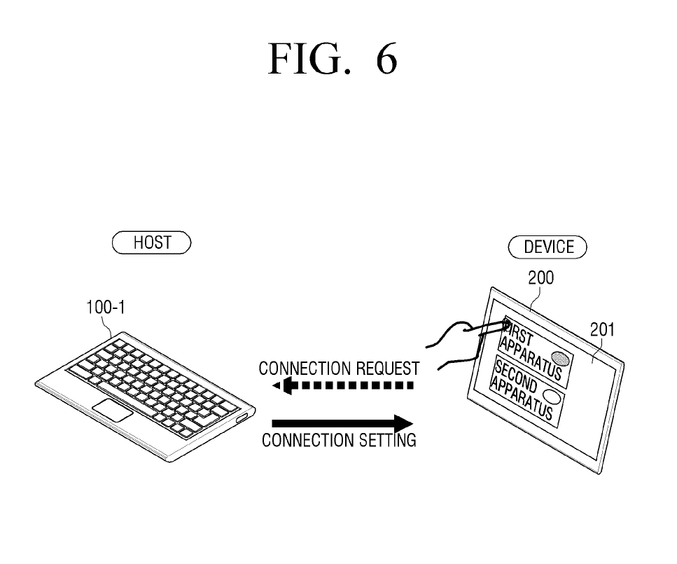

Referring to FIG. 6, if one of a plurality of searched host apparatuses is selected (i.e., host apparatus 100-1), the display apparatus 200 may request a connection with respect to the selected host apparatus 100. In response to the selection, the host apparatus 100-1 and the display apparatus 200 perform a connection setting to form a wireless link.

Hereinafter, it is assumed that the first host apparatus 100-1 is connected for convenience of explanation.

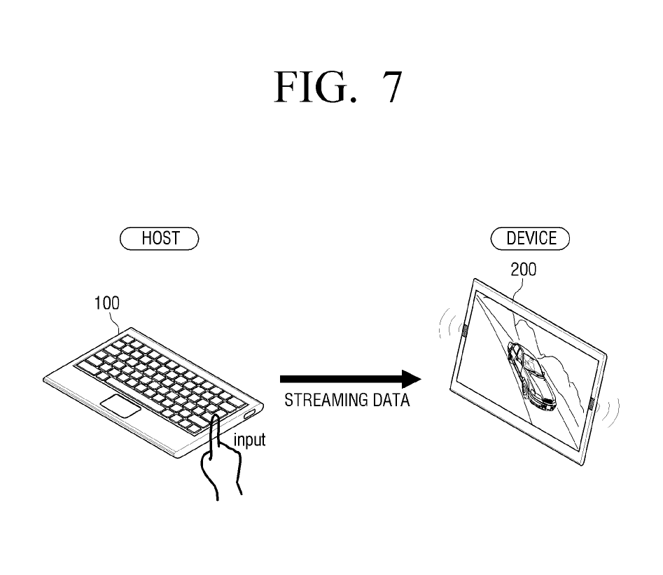

Referring to FIG. 7, if the host apparatus 100 and the display apparatus 200 are connected wirelessly, the host apparatus 100 may generate image data corresponding to a control command, encode the generated image data, and transmit the encoded image data having a 5 GHz band to the display apparatus 200 using a wireless communication method. The image data which is transmitted in the above process may be real-time streaming data including voice data as illustrated in the drawing. As described above, image data is transmitted through a wireless communication method of 5 GHz, and thus, the host apparatus 100 and the display apparatus 200 may communicate with each other even if they are separated from each other by more than 30 m, and even if there is a wall between the two apparatuses. In addition, as image data is encoded and transmitted, image data of high resolution may be transmitted using a low wireless resource.

The display apparatus 200 receives image data which is transmitted through the above method and performs decoding with respect to the received image data. The display apparatus 200 may display the decoded image data on the screen and output voice data as sound.

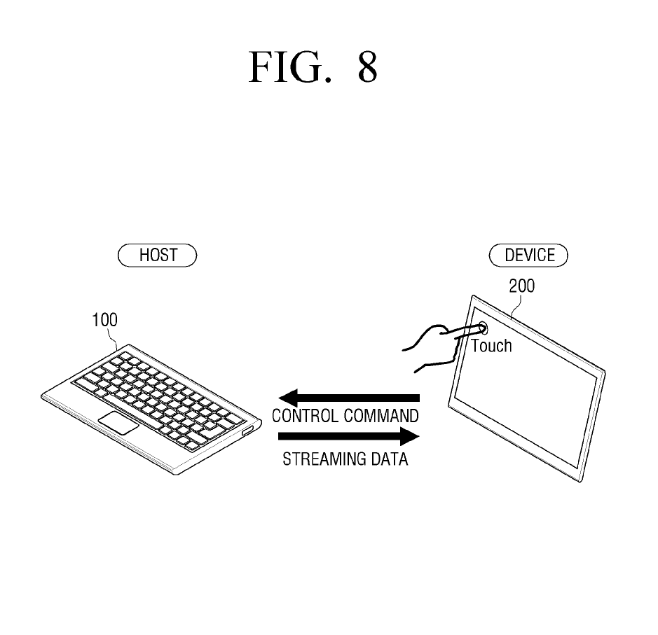

In the above process, if a user inputs a touch on the touch screen of the display apparatus 200, for example, if a user inputs a pause command while a movie is being played, the display apparatus 200 may transmit the control command which is input through a wireless communication method to the host apparatus 100 using a wireless communication method as illustrated in FIG. 8. The transmission of a control command may be performed while image data is being received, as described above.

The host apparatus 100 which receives a control command may perform an operation corresponding to the input control command. Specifically, as the pause command is input from the user at the display apparatus 200, the host apparatus 100 may generate a movie scene which is paused at the time when the control command is input as image data, and perform an encoding and transmission operation with respect to the generated image data.

If a user's control command is a video chat command, the display apparatus 200 transmits the received control command to the host apparatus 100 through a wireless communication method. The host apparatus 100 which receives the control command transmits control data to operate the photographing unit 240 of the display apparatus 200 to the display apparatus 200.

Accordingly, the photographing unit 240 of the display apparatus 200 performs a photographing operation, and transmits photographing data generated by the photographing operation to the host apparatus through a wireless communication method.

The host apparatus 100 which receives the photographing data generates image data including the received photographing data, and transmits encoded image data to the display apparatus 200 by repeating the above-described operation.

Through the above process, the display apparatus 200 may display an image received from an external apparatus and an image photographed by a photographing unit on one screen.

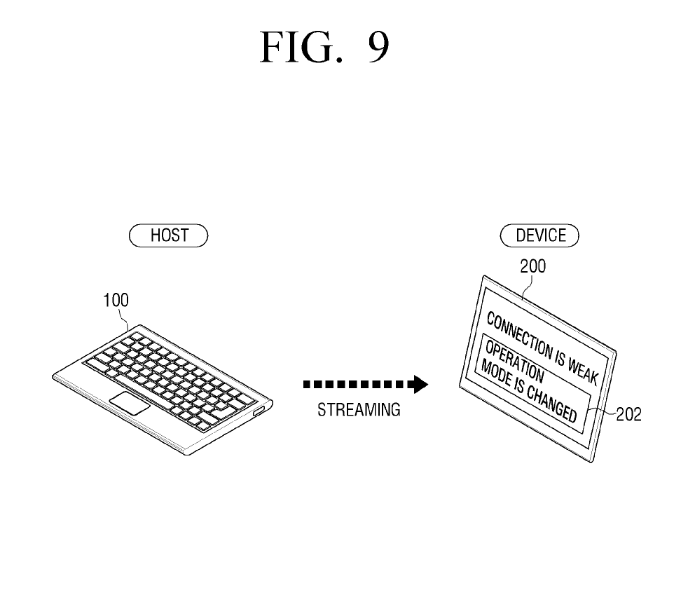

Meanwhile, if the display apparatus 200 is moved during the above-described operation, and thus, a wireless connection state with the host apparatus 100 becomes weak or is cut off, the display apparatus 200 determines that an image transmitted from the host apparatus 100 cannot be displayed, and may display to a user that a display mode needs to be changed, as illustrated in FIG. 9. For example, if a user uses a display apparatus at home as a detachable apparatus and takes the display apparatus outside the home, the display apparatus may detect that a wireless signal becomes weak, and thus, may automatically ask the user whether to turn off power or convert the signal to Android through a pop-up menu. If another connectable host apparatus is searched and detected, the display apparatus may ask the user whether to connect to the searched and detected host apparatus.

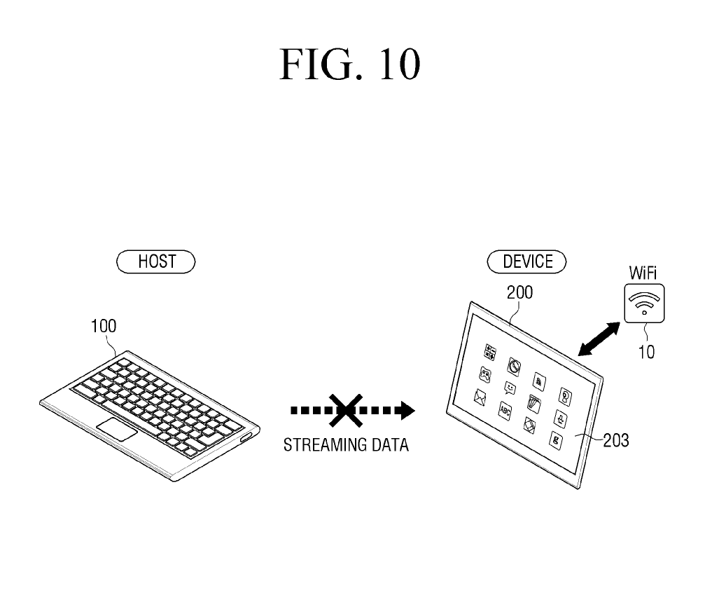

If the user changes the display mode, the display apparatus 200 may display image data 202 generated by its own operating system as illustrated in FIG. 10. In this case, the display apparatus 200 may be connected to an Internet network 10 through a wireless communication method.

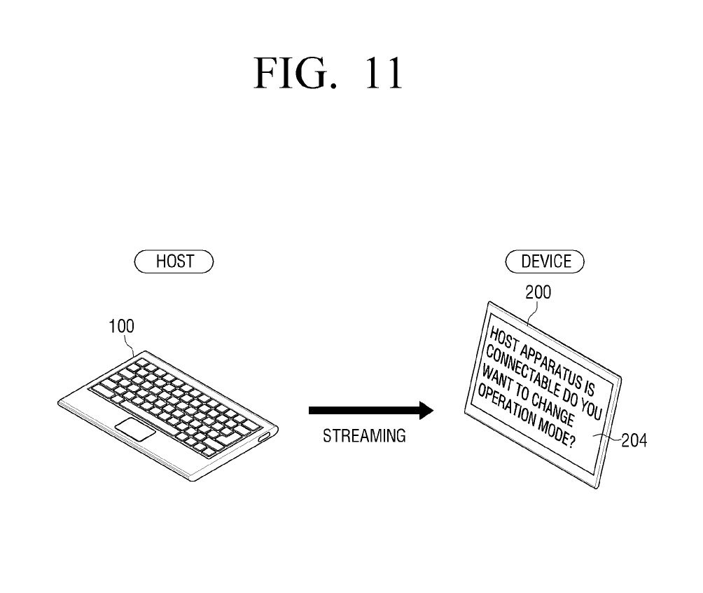

Meanwhile, if a wireless connection with the host apparatus 100 is restored or becomes higher than a predetermined state while the display apparatus 200 operates in the second display mode, the display apparatus 200 determines that an image transmitted from the host apparatus 100 cannot be displayed, and may display to a user that the display mode can be changed as illustrated in FIG. 11.

If the user changes the display mode, the above-described screen in FIG. 7 or FIG. 8 may be displayed. Meanwhile, if the user selects the third display mode instead of the first display mode, the display apparatus 200 may display the first image data received from the host apparatus 100 and the second image data generated therein together, as illustrated in FIG. 12.

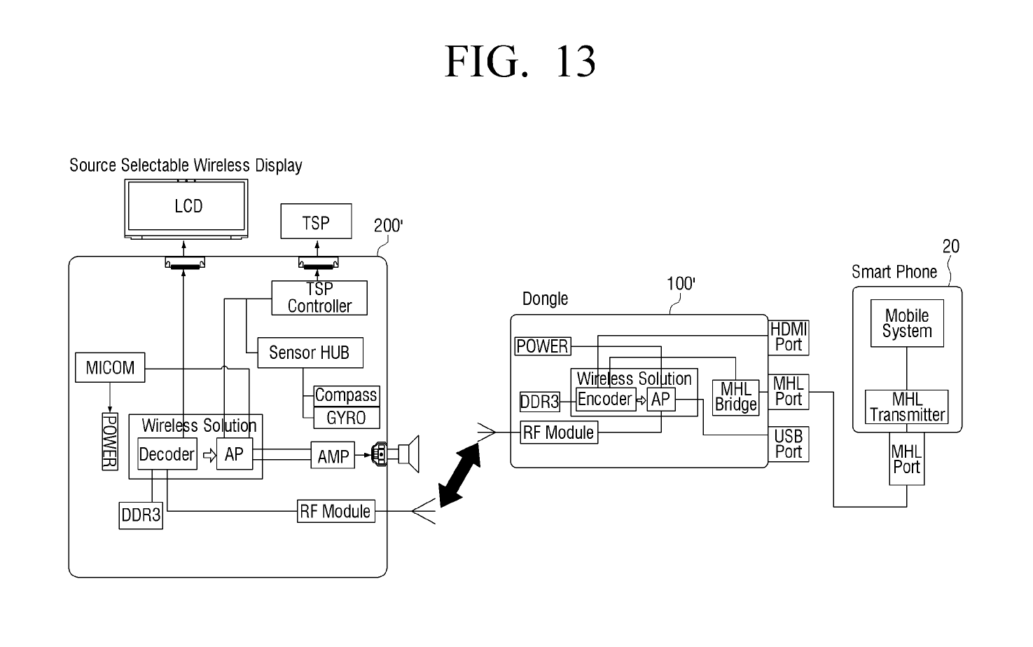

FIGS. 13 to 17 are views provided to explain an operation of a wireless detachable system according to another exemplary embodiment.

Specifically, FIG. 13 illustrates an example of operations in a case where a host apparatus is configured in a dongle type configuration which is connected to a smart phone.

Referring to FIG. 13, a host apparatus 100′ is a dongle type configuration which operates by being connected to a smart phone 20. Accordingly, the host apparatus 100′ receives image data from the smart phone, performs hardware-encoding with respect to the received image data, and transmits the hardware-encoded image data to a display apparatus 200′. In this case, the transmitted image data may include voice data.

The display apparatus 200′ may decode the received image data, and display the decoded image data.

Referring to the above described example of operation, a wireless detachable system according to an exemplary embodiment may display an image of the smart phone on a display apparatus without a wired connection. Meanwhile, in the exemplary embodiment, although only a host apparatus is illustrated as being configured in a dongle type configuration, a display apparatus may also be configured in a dongle type configuration. That is, the display apparatus 200 according to an exemplary embodiment may be in a dongle type configuration which is mounted on a general monitor or on a television.

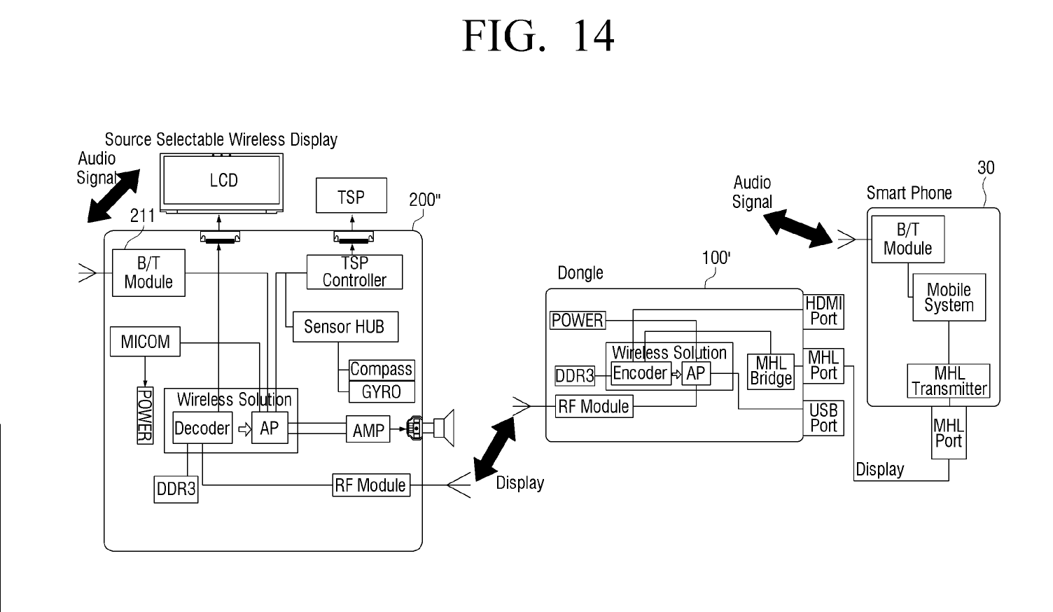

FIG. 14 illustrates an example of the second operation in a case where a host apparatus is configured in a dongle type configuration which is connected to a smart phone.

Referring to FIG. 14, a smart phone 30 transmits image data to the host apparatus 100′, and transmits voice data directly to a display apparatus 200″ through a Bluetooth method.

Accordingly, the display apparatus 200″ receives encoded image data through the host apparatus 100′, and receives voice data through a Bluetooth method. The display apparatus 200″ may output the received image data and the received voice data. Herein, the received voice data may be data which is or is not related to the image data. For example, if a content of data such as a movie or a drama is transmitted to the display apparatus 200, the content may be transmitted in the connection state of FIG. 13, and only when a call is received through a smart phone, voice data may be transmitted through a separate Bluetooth method.

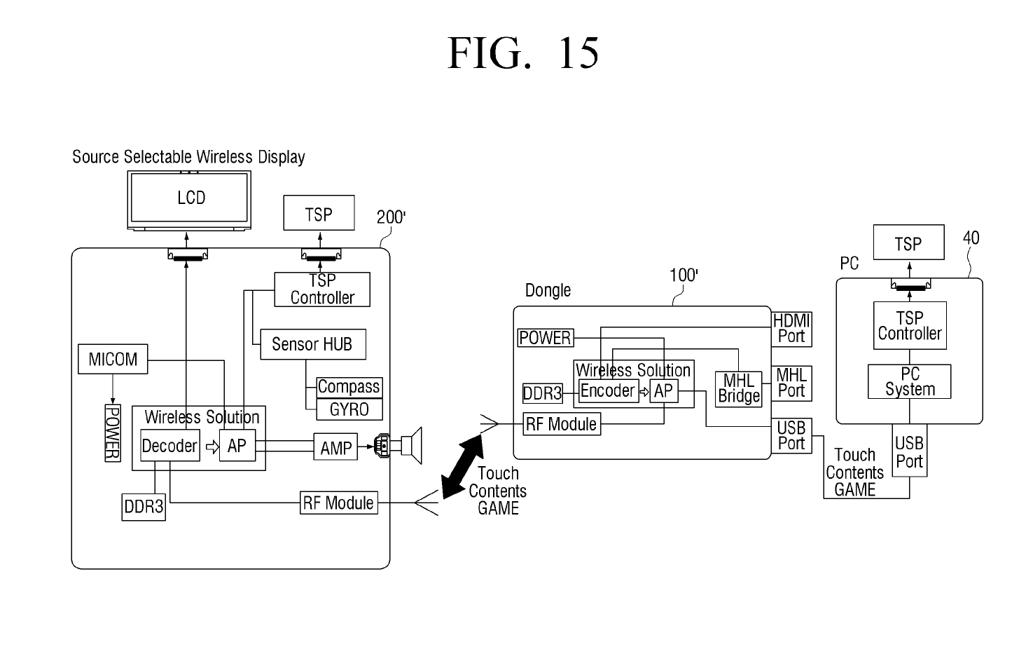

FIG. 15 is a view provided to explain an exemplary embodiment where a host apparatus is configured as a dongle type configuration and a PC.

FIG. 15 is a view illustrating an example where the display apparatus 200′ operates as a touch pad. Specifically, the display apparatus 200′ may transmit touch coordinates which are input through a touch screen to the host apparatus 100′ through a wireless communication method.

The host apparatus 100′ transmits the touch coordinates which are transmitted through a wireless communication method to the PC.

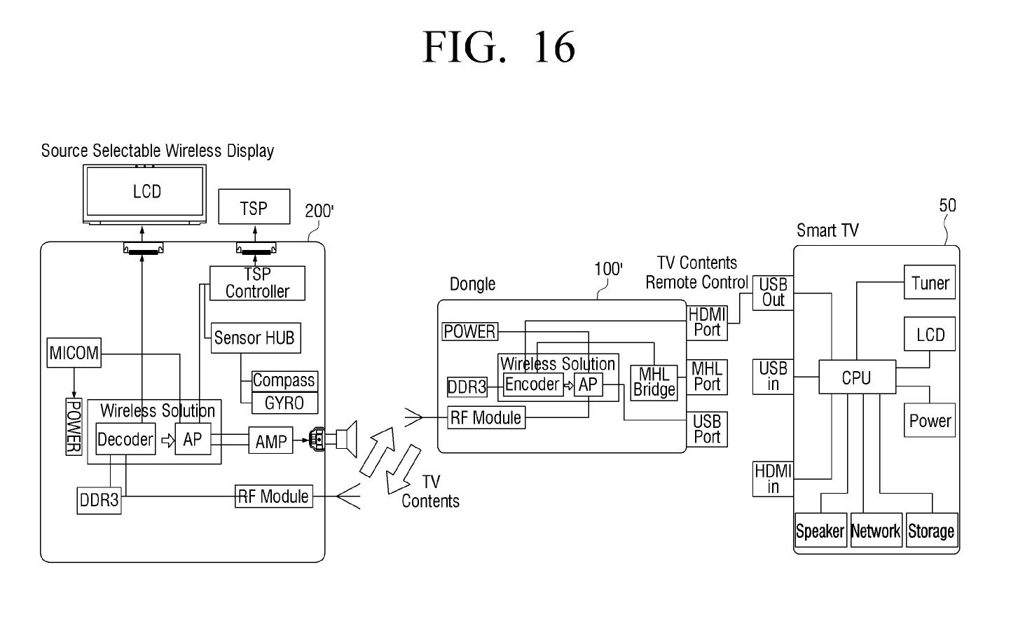

FIG. 16 is a view provided to explain an exemplary embodiment where a host apparatus is configured as a dongle type configuration and a television.

Referring to FIG. 16, the host apparatus 100′ is a dongle type configuration which operates by being connected to a TV 50. Accordingly, the host apparatus 100′ receives video data (HDMI) from the TV 50, performs hardware-encoding with respect to the received image data and voice data, and transmits the hardware-encoded image data and voice data to the display apparatus 200′.

The display apparatus 200′ may decode the received image data and voice data, and display the decoded image data and the decoded voice data.

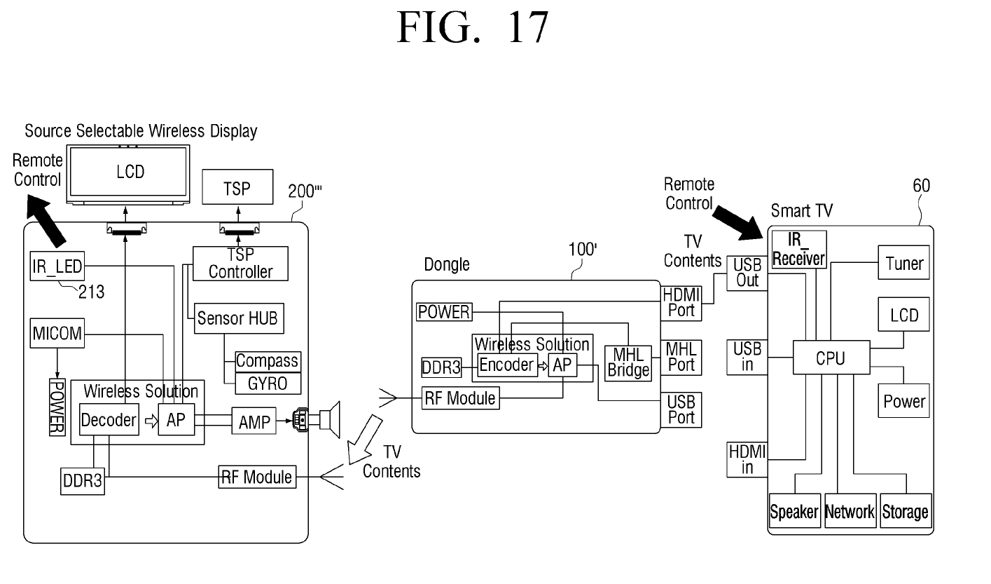

FIG. 17 is a view provided to explain another exemplary embodiment where a host apparatus is configured as a dongle type configuration and a television. Specifically, the display apparatus 200′″ of FIG. 17 performs the functions of both a display apparatus of FIG. 3 and a TV remote controller simultaneously.

Specifically, the feature in which the display apparatus 200′″ receives and displays image data is the same as the feature of FIG. 16, and thus, further description will not be provided.

The display apparatus 200′″ receives a touch command on a touch screen. The display apparatus 200′″ may transmit the input touch command to a TV 60 using a one-way communication (IR). Accordingly, an image display operation of the TV 60 may be changed according to the received command.

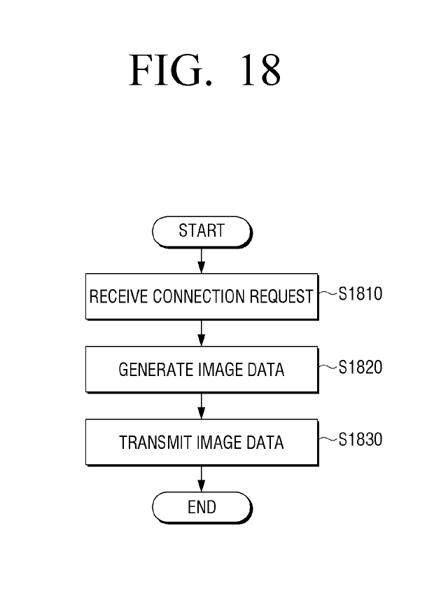

FIG. 18 is a flowchart provided to explain a control operation of a host apparatus according to an exemplary embodiment.

Referring to FIG. 18, a request for a wireless connection is received from the display apparatus 200 (operation S1810). In this case, the host apparatus 100 may receive apparatus information of the display apparatus (for example, resolution information and whether there is a web cam, speaker, etc.).

Subsequently, image data to be displayed on the display apparatus 200 is generated (operation S1820). Specifically, the host apparatus 100 may generate image data to be displayed on the display apparatus 200 as real-time streaming data. In this case, the host apparatus 100 may generate streaming data including voice data. The streaming data may be data according to an HDMI method.

In this case, encoding may be performed with respect to the generated image data. Specifically, the generated image data may be hardware-encoded using an encoder which performs hardware-encoding independently without any control of the controller of the host apparatus. Herein, the encoding may use a standard H.264 method, or may use another encoding method which may prevent deterioration of image quality and perform processing in sufficient bandwidth.

The generated image data is transmitted to the display apparatus through a wireless communication method which uses a predetermined band (operation S1830). Specifically, the hardware-encoded image data may be transmitted to the display apparatus 200 using 802.11n (bandwidth of 300 Mbps) with a 5 GHz band which has a sufficient use distance in a household or using 802.11ac (bandwidth of 1 Gbs) method. Meanwhile, in the exemplary embodiment, although a WiFi (Wireless Lan) method is described as being used, other wireless communication methods using the above band may also be used. In addition, in the exemplary embodiment, 5 GHz band is used, but other bands around 5 GHz may also be used.

As such, the method of controlling a host apparatus according to an exemplary embodiment may perform a wireless connection or cut off a wireless connection in response to a request from the display apparatus 200, and thus, a user may set a connection between the display apparatus and the host apparatus easily. In addition, the method of controlling a host apparatus according to an exemplary embodiment encodes image data and transmits the encoded image data to the display apparatus 200, and thus, the image data of high resolution may be transmitted with a low wireless resource, and image data photographed by the display apparatus 200 and various control data may be received through the same wireless communication method. The method of controlling a host apparatus of FIG. 18 may be performed in a host apparatus having the configuration of FIG. 2, and may also be performed in a host apparatus having other configurations.

In addition, the above-described method of controlling a host apparatus may be realized as a program (or application) including an executable algorithm which can be executed in a computer, and the program may be stored in a non-transitory computer readable medium and provided therein. The non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as a CD, DVD, hard disk, Blu-ray disk, USB, memory card, and ROM and provided therein.

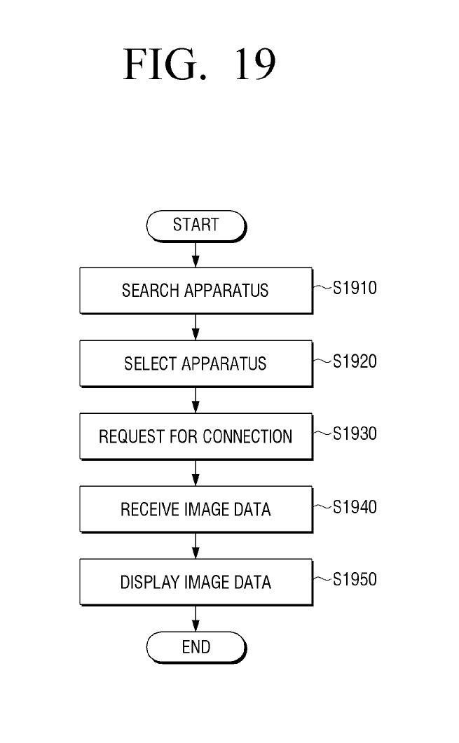

FIG. 19 is a flowchart provided to explain a control operation of a display apparatus according to an exemplary embodiment.

Referring to FIG. 19, a connectable host apparatus is searched (operation S1910). Specifically, an apparatus which supports a predetermined protocol may be searched from among apparatuses which support 80.211n or 802.11ac method using 5 GHz band. That is, a host apparatus which can transmit image data wirelessly may be searched.

A host apparatus to be connected is searched from among the searched connectable host apparatuses (operation S1920). Specifically, the searched connectable host apparatuses are displayed, and a host apparatus to be connected may be selected by a user from among the displayed host apparatuses. If a host apparatus has a history of being connected previously, the host apparatus may be connected automatically. Meanwhile, if there are a plurality of host apparatuses which have a history of being connected previously, each host apparatus may be connected automatically according to priority or may be connected by a user's selection.

A wireless connection with respect to the selected host apparatus is requested (operation S1930). Specifically, a wireless connection to receive image data from the selected host apparatus may be requested.

Subsequently, image data is received from the connected host apparatus through a wireless communication method which uses a predetermined band (operation S1940). Specifically, the image data may be received from the host apparatus 100 using 802.11n (bandwidth of 300 Mbps) with a 5 GHz band which has a sufficient use distance in a household or using 802.11ac (bandwidth of 1 Gbs) method to the display apparatus 200. Meanwhile, in the exemplary embodiment, although a WiFi (Wireless Lan) method is described as being used, other wireless communication methods using the above band may also be used. In addition, in the exemplary embodiment, 5 GHz band is used, but other bands around 5 GHz may also be used.

In this case, if the received image data is encoded, the received image data is decoded. Specifically, the received data is decoded by using a decoding method corresponding to the encoding method of the host apparatus 100, and data according to an HDMI method may be output. Herein, the decoding may use standard H.264 method, and may also use other decoding methods than the standard H.264 method. Meanwhile, if the received data is data according to an HDMI method where image data and voice data is combined, the received data may be divided into image data and voice data, and decoding may be performed for each data.

The received image data is displayed (operation S1950). Specifically, the received image data may be displayed on the selected host apparatus. Meanwhile, if a user selects the second display mode and the third display mode, an image which is generated therein may be displayed, or the generated image and the received image may be displayed together.

Meanwhile, if a touch command is input while an image is being displayed, the touch command which is input while the image is being received may be transmitted to a host apparatus. In addition, if image data is generated through a photographing unit or voice data is generated, the generated image data or voice data may be transmitted to the host apparatus.

As such, the method of controlling a display apparatus according to exemplary embodiment allows the display apparatus 200 to select a host apparatus, and thus, user convenience may be improved. In addition, even if a wireless connection between the display apparatus 200 and the host apparatus 100 becomes weak or cuts off, the display apparatus 200 may still operate using its own operating system, and thus, usability and usability scope of the display apparatus 200 can be improved. The method of controlling a display apparatus of FIG. 19 may be performed in a display apparatus having the configuration of FIG. 3 or FIG. 4, and may also be performed in a display apparatus having other configurations.

The above-described method of controlling a display apparatus may be realized as a program (or application) including an executable algorithm which can be executed in a computer, and the program may be stored in a non-transitory computer readable medium and provided therein.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus which is connectable to a host apparatus wirelessly, comprising:
a communication interface configured to search for connectable host apparatuses;
a user interface configured to select a host apparatus to be connected to the display apparatus from among the searched host apparatuses; and
a controller configured to request transmission of image data from the selected host apparatus, to control the communication interface to receive image data corresponding to the request through a wireless communication method, and to control the user interface to display the received image data.

2. The apparatus as claimed in claim 1, wherein the communication interface searches for an apparatus which supports a predetermined protocol from among apparatuses which support the wireless communication method.

3. The apparatus as claimed in claim 2, wherein the wireless communication method is a 802.11n or 802.11ac method using a 5 GHz band.

4. The apparatus as claimed in claim 1, wherein the user interface displays the searched host apparatuses and receives a selection regarding one of the displayed apparatuses from a user.

5. The apparatus as claimed in claim 1, wherein the user interface selects a pre-connected apparatus from among the searched host apparatuses.

6. The apparatus as claimed in claim 1, wherein the communication interface receives the image data and voice data corresponding to the image data together,
wherein the user interface displays the image data and outputs the voice data simultaneously.

7. The apparatus as claimed in claim 1, further comprising:
a photographing unit configured to generate photographing data by photographing a subject,
wherein the communication interface transmits the generated photographing data to the host apparatus using the wireless communication method while receiving the image data.

8. The apparatus as claimed in claim 1, further comprising:
a microphone configured to generate voice data by reading out a voice,
wherein the communication interface transmits the generated voice data to the host apparatus using the wireless communication method while receiving the image data.

9. The apparatus as claimed in claim 1, wherein the user interface displays the image data and includes a touch screen through which touch coordinates are input,
wherein the communication interface transmits the input touch coordinates to the host apparatus using the wireless communication method while receiving the image data.

10. The apparatus as claimed in claim 1, wherein the controller generates second image data by an operation of an operating system of the display apparatus,
wherein the user interface displays at least one of the received image data and the generated second image data.

11. A method of controlling a display apparatus which is connectable to a host apparatus wirelessly, the method comprising:
searching connectable host apparatuses;
selecting a host apparatus to be connected to the display apparatus from among the searched host apparatuses;
requesting transmission of image data from the selected host apparatus;
receiving image data corresponding to the request through a wireless communication method; and
displaying the received image data.

12. The method as claimed in claim 11, wherein the searching comprises searching an apparatus which supports a predetermined protocol from among apparatuses which support the wireless communication method.

13. The method as claimed in claim 12, wherein the wireless communication method is a 802.11n or 802.11ac method using a 5 GHz band.

14. The method as claimed in claim 11, wherein the selecting comprises displaying the searched host apparatuses and receiving a selection regarding one of the displayed apparatuses from a user.

15. The method as claimed in claim 11, wherein the selecting comprises selecting a pre-connected apparatus from among the searched host apparatuses.

16. The method as claimed in claim 11, wherein the receiving comprises receiving the image data and voice data corresponding to the image data together,
wherein the displaying comprises displaying the image data and outputting the voice data simultaneously.

17. The method as claimed in claim 11, further comprising:
generating photographing data by photographing a subject, and
transmitting the generated photographing data to the host apparatus using the wireless communication method while receiving the image data.

18. The method as claimed in claim 11, further comprising:
generating voice data by reading out a voice; and
transmitting the generated voice data to the host apparatus using the wireless communication method while receiving the image data.

19. The method as claimed in claim 11, further comprising:
receiving touch coordinates on a touch screen; and
transmitting the input touch coordinates to the host apparatus using the wireless communication method while receiving the image data.

20. The method as claimed in claim 11, further comprising:
generating second image data by an operation of an operating system of the display apparatus,
wherein the displaying comprises displaying at least one of the received image data and the generated second image data.

21. A computer readable recording medium including a program to perform a method of controlling a display apparatus which is connectable to a host apparatus wirelessly,
wherein the controlling method comprises:
searching connectable host apparatuses;
selecting a host apparatus to be connected to the display apparatus from among the searched host apparatuses;
requesting for transmission of image data with respect to the selected host apparatus;
receiving image data corresponding to the request through a wireless communication method; and
displaying the received image data.
